(19) United States
(12) Patent Application Publication
(10) Pub. No.: US 2025/0004212 A1
(43) Pub. Date: Jan. 2, 2025

(54) OPTICAL COUPLER, OPTICAL COUPLING MEMBER, VISIBLE LIGHT SOURCE MODULE, AND OPTICAL ENGINE

(71) Applicant: TDK CORPORATION, Tokyo (JP)

(72) Inventors: Yasuhiro TAKAGI, Tokyo (JP); Makoto Fukuda, Tokyo (JP)

(73) Assignee: TDK CORPORATION, Tokyo (JP)

(21) Appl. No.: 18/754,285

(22) Filed: Jun. 26, 2024

(30) Foreign Application Priority Data
Jun. 28, 2023 (JP) 2023-106470

(51) Int. Cl. G02B 6/42; G02B 6/293; G02B 26/10

(52) U.S. Cl. CPC G02B 6/4203; G02B 26/105; G02B 6/29344

(57) ABSTRACT

An optical coupler of the present disclosure includes three light input ports configured to allow a plurality of laser light beams having different wavelengths to be respectively incident therethrough, two light output ports configured to allow three laser light beams to be coupled and emitted therethrough, three light input side optical waveguides configured to respectively extend from the three light input ports, two light output side optical waveguides configured to respectively extend from the two light output ports, and an optical coupling part configured to have the three light input side optical waveguides and the two light output side optical waveguides to be connected thereto.

### BACKGROUND OF THE INVENTION

### Field of the Invention

The present disclosure relates to an optical coupler, an optical coupling member, a visible light source module, and an optical engine.

### Description of Related Art

Currently, glasses-type terminals are being studied in XR technologies such as virtual reality (VR) and augmented reality (AR). Particularly, in recent years, retinal scanning displays allowing a user to visually recognize images by forming images of light used for two-dimensional scanning on the user's retina have attracted attention. In retinal scanning displays, generally, three-color visible light emitted from light sources such as light emitting diodes (LEDs) or laser diodes (LDs) respectively corresponding to colors of R (red), G (green), and B (blue) are coupled on one optical axis. The coupled three-color visible light are transmitted to an image display part. The image display part performs two-dimensional scanning of transmitted light and causes it to be incident on the user's pupil. An image of this incident light is formed on the user's retina so that the user visually recognizes the image. In this case, the retina serves as a screen displaying images.

For example, Patent Document 1 discloses a constitution of a retinal projection display using a Mach-Zehnder optical modulator.

### PATENT DOCUMENTS

[Patent Document 1] Japanese Patent No. 6728596
[Patent Document 2] Japanese Patent No. 6787397
[Patent Document 3] Japanese Patent No. 6572377
[Patent Document 4] Japanese Unexamined Patent Application, First Publication No. 2012-48071
[Patent Document 5] Japanese Unexamined Patent Application, First Publication No. 2020-27170

### SUMMARY OF THE INVENTION

In the retinal projection display disclosed in Patent Document 1, a plurality of optical waveguides are close to each other in an emission portion, but coupling is not performed, and therefore an optical axis of each wavelength varies so that control of emission light becomes complicated.

In addition, Patent Document 2 discloses a visible light modulator using a lithium niobate film. There is a demand for RGB optical couplers that can be connected to or integrated with a visible light modulator using a lithium niobate film, but this has not yet been studied.

Regarding coupling of visible light, directional couplers are generally being studied (for example, refer to Patent Document 3). These are constituted using a glass-based material and have excellent stability. However, when a lithium niobate substrate having a significant Δn is used, a coupling length increases so that miniaturization cannot be achieved.

Patent Document 4 and Patent Document 5 disclose constitutions of RGB couplers using a multimode interferometer (MMI), and both are made of a glass-based material. However, neither of them discloses a constitution using a lithium niobate film.

In an MMI optical coupler, a plurality of input signals are input using a plurality of waveguide ports on a light input side, a single waveguide port is used for an output signal on a light output side, and all input signals are coupled and output as an output signal.

As of now, optical couplers that can cope with a high output have not yet been studied.

An object of the present disclosure is to provide an optical coupler that can be connected to or integrated with an optical modulator using a lithium niobate film and can cope with a high output, an optical coupling member including the same, a visible light source module, and an optical engine.

In order to resolve the foregoing problems, the present disclosure provides the following means.

Aspect 1 of the present disclosure is an optical coupler for coupling a plurality of laser light beams having different wavelengths. The optical coupler includes a plurality of light input ports configured to allow the plurality of laser light beams to be respectively incident therethrough, two or more light output ports configured to allow the plurality of laser light beams to be coupled and emitted therethrough, a plurality of light input side optical waveguides configured to respectively extend from the plurality of light input ports, two or more light output side optical waveguides configured to respectively extend from the two or more light output ports, and an optical coupling part configured to have the plurality of light input side optical waveguides and the two or more light output side optical waveguides connected thereto.

According to Aspect 2 of the present disclosure, in the optical coupler according to Aspect 1, the plurality of light input ports include two or more light input ports for at least one light beam.

According to Aspect 3 of the present disclosure, in the optical coupler according to Aspect 2, the plurality of light input ports are constituted of two or more light input ports for each of all laser light beams.

According to Aspect 4 of the present disclosure, in the optical coupler according to any one of Aspects 1 to 3, in the two or more light output ports, an interval between light output ports farthest away from each other is 25 μm or smaller.

According to Aspect 5 of the present disclosure, in the optical coupler according to any one of Aspects 1 to 4, in two or more light input ports provided for one light beam, an interval between adjacent light input ports is 0.5 μm or smaller.

According to Aspect 6 of the present disclosure, in the optical coupler according to any one of Aspects 1 to 5, a thickness of a slab portion provided on an inward side of the light input side optical waveguides is larger than a thickness of a slab portion provided on an outward side of the light input side optical waveguides.

According to Aspect 7 of the present disclosure, in the optical coupler according to any one of Aspects 1 to 6, the optical coupling part is a multimode-interference-type coupling part.

Aspect 8 of the present disclosure is an optical coupling member that includes a substrate configured to be made of a material different from lithium niobate, and an optical coupling function layer configured to be formed on a main surface of the substrate and be constituted of a lithium niobate film. The optical coupler according to any one of Aspects 1 to 7 is formed in the optical coupling function layer.

Aspect 9 of the present disclosure is a visible light source module that includes the optical coupling member according to Aspect 8, and a plurality of visible laser light sources configured to emit visible light lasers coupled by the optical coupling member.

Aspect 10 of the present disclosure is an optical coupling member with an optical modulation function that includes a Mach-Zehnder optical modulator configured to be provided inside the optical coupling function layer of the optical coupling member according to Aspect 8.

Aspect 11 of the present disclosure is a visible light source module that includes the optical coupling member with an optical modulation function according to Aspect 10, and a plurality of visible laser light sources configured to emit visible light lasers coupled by the optical coupling member with an optical modulation function.

Aspect 12 of the present disclosure is an optical engine that includes the visible light source module according to Aspect 9, and a light scanning mirror configured to reflect light emitted from the visible light source module at various angles for image display.

Aspect 13 of the present disclosure is an optical engine that includes the visible light source module according to Aspect 11, and a light scanning mirror configured to reflect light emitted from the visible light source module at various angles for image display.

According to the present disclosure, it is possible to provide an optical coupler that can be connected to or integrated with an optical modulator using a lithium niobate film and can cope with a high output.

### BRIEF DESCRIPTION OF THE DRAWINGS

FIG. 1 is a schematic plan view showing an optical coupler according to a first embodiment.

FIG. 2 is a schematic plan view showing an optical coupler according to a second embodiment.

FIG. 3 is a schematic plan view showing an optical coupler according to a third embodiment.

FIG. 4 is a schematic cross-sectional view, which is cut along X-X′ in FIG. 1, of an optical coupling member in which the constituent element shown in FIG. 1 is formed in an optical coupling function layer made of lithium niobate.

FIG. 5 is a schematic cross-sectional view cut along a YZ plane when an MMI optical coupling part has a trapezoidal cross section.

FIG. 6 is a schematic cross-sectional view cut along a YZ plane when a slab portion is provided on a substrate side of an MMI optical coupling part.

FIG. 7 is a schematic cross-sectional view cut along a YZ plane when an MMI optical coupling part has a trapezoidal cross section and a slab portion is provided on the substrate side.

FIG. 8 is a schematic plan view of a modification example of an optical coupling member according to the embodiment of the present disclosure.

FIG. 9 is a schematic plan view of a visible light source module according to the first embodiment.

FIG. 10 is a schematic plan view of a visible light source module according to the second embodiment.

FIG. 11 is an explanatory conceptual diagram of an optical engine according to the present embodiment.

FIG. 12A is another explanatory conceptual diagram of the optical engine according to the present embodiment.

FIG. 12B is another explanatory conceptual diagram of the optical engine according to the present embodiment.

FIG. 13 is a view showing a relationship between a laser beam diameter corresponding to each of Examples and a distance Z from a laser emission surface.

### DETAILED DESCRIPTION OF THE INVENTION

Hereinafter, embodiments will be described in detail suitably with reference to the diagrams. In the drawings used in the following description, in order to make characteristics easy to understand, characteristic portions may be illustrated in an enlarged manner for the sake of convenience, and dimensional ratios or the like of each constituent element may differ from actual values thereof. Materials, dimensions, and the like illustrated in the following description are merely exemplary examples. The present disclosure is not limited thereto and can be suitably changed and performed within a range in which the effects of the present disclosure are exhibited.

### Optical Coupler (First Embodiment)

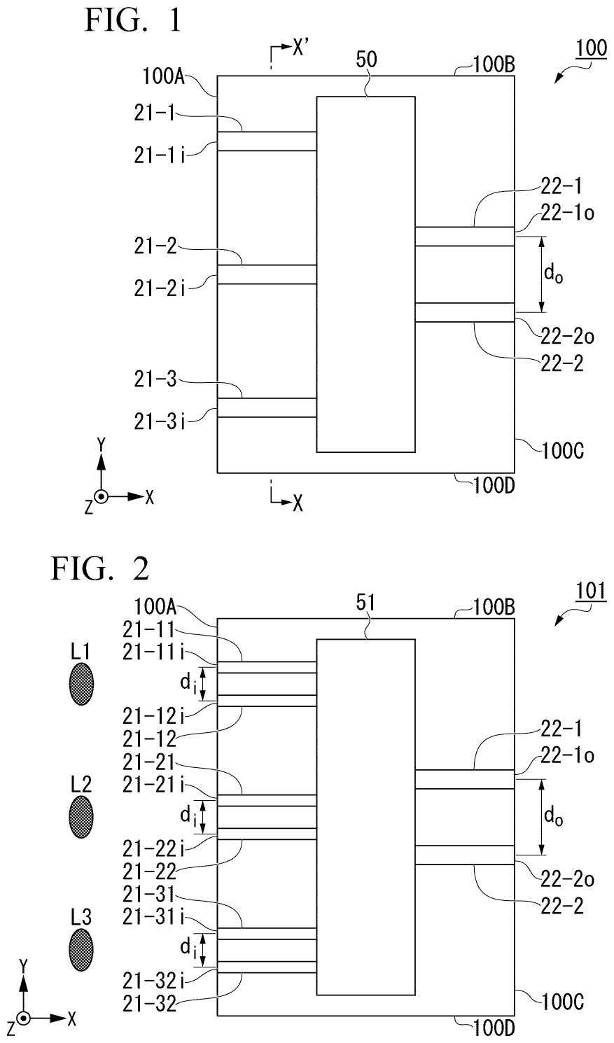

FIG. 1 is a schematic plan view showing an optical coupler according to a first embodiment.

An optical coupler 100 shown in FIG. 1 is an optical coupler for coupling three laser light beams having different wavelengths and includes three light input ports (21-1i, 21-2i, and 21-3i) allowing three laser light beams to be respectively incident therethrough, two light output ports (22-1o and 22-2o) allowing three laser light beams to be coupled and emitted therethrough, three light input side optical waveguides (21-1, 21-2, and 21-3) respectively extending from the three light input ports (21-1i, 21-2i, and 21-3i), two light output side optical waveguides (22-1 and 22-2) respectively extending from the two light output ports (22-1o and 22-2o), and an optical coupling part 50 having the three light input side optical waveguides (21-1, 21-2, and 21-3) and the two light output side optical waveguides (22-1 and 22-2) connected thereto.

In FIG. 1, an X direction is a direction orthogonal to a side surface 100A on which the light input ports are disposed, a Y direction is a direction orthogonal to the X direction, and a Z direction is a direction orthogonal to a plane formed in the X direction and the Y direction.

The optical coupler 100 is constituted to include two light output ports for outputting laser light and include two light output side optical waveguides respectively leading to the two light output ports. By providing a plurality of light output side optical waveguides, the power density of laser light guided through the optical waveguides can be dispersed so that damage to the optical waveguides can be curbed. Particularly, this is an effective countermeasure against damage to the optical waveguides caused by high-output lasers (for example, laser light of 100 mW or higher, or the like).

As an example of dimensions of the light input side optical waveguides and the light output side optical waveguides, the width can be 0.1 to 5 μm and the height can be 0.1 to 5 μm.

The optical coupler 100 is constituted to be able to cope with a case in which three laser light beams having different wavelengths are input, but the constitution is not limited for three laser light beams having different wavelengths, and it can be constituted for two laser light beams having different wavelengths. It can have a constitution in which the number of light input ports and the number of light input side optical waveguides leading to the light input ports are changed in accordance with the number of laser light beams.

Input laser light beams having different wavelengths can be visible light, but they are not limited to visible light. It may be constituted to be used for visible laser light and laser light other than visible light.

The optical coupler 100 has four side surfaces 100A, 100B, 100C, and 100D and is constituted to have the three light input ports provided on the first side surface 100A and the two light output ports provided on the third side surface 100C, but it can also be constituted to have the two light output ports provided on the second side surface 100B or the fourth side surface 100D.

It is preferable that an interval dₒ between the two light output ports 22-1o and 22-2o be 25 μm or smaller. This is because laser light beams appear as one beam, resulting in a clear video image when the optical coupler 100 is applied to retinal projection XR glasses or the like. Here, as shown in FIG. 1, the interval dₒ is a distance between the center of the light output port 22-1o and the center of the light output port 22-2o.

The optical coupling part 50 is a multimode-interference-type (MMI) coupler. However, a directional coupler or a Y-shaped coupler may also be used. The optical coupling part 50 is a three-input two-output type MMI optical coupler.

In the optical coupler 100, the MMI optical coupling part 50 is constituted of one stage, but it may be constituted of two or more stages.

It is preferable that the light input side optical waveguides and the light output side optical waveguides connected to the optical coupling part 50 (MMI optical coupler) include tapered portions which become wider toward the corresponding input and output ports of the optical coupling part 50. The light input side optical waveguides and the light output side optical waveguides connected to the optical coupling part 50 are set such that single-mode laser light (zero-order mode, basic mode) is propagated, and the optical coupling part 50 is set such that multimode laser light (zero-order mode to higher-order mode) is propagated. For this reason, when light is input to the optical coupling part 50 from the light input side optical waveguides and is output to the light output side optical waveguides from the optical coupling part 50, a coupling loss will occur due to mode inconsistency between the single mode and the multimode of incident light. In contrast, if tapered portions are provided in the input and output ports, mode inconsistency between the single mode and the multimode of incident light is relaxed and a coupling loss is reduced. As the widths of the tapered portions become sufficiently wider, mode inconsistency is further relaxed and an effect of reducing a coupling loss also increases.

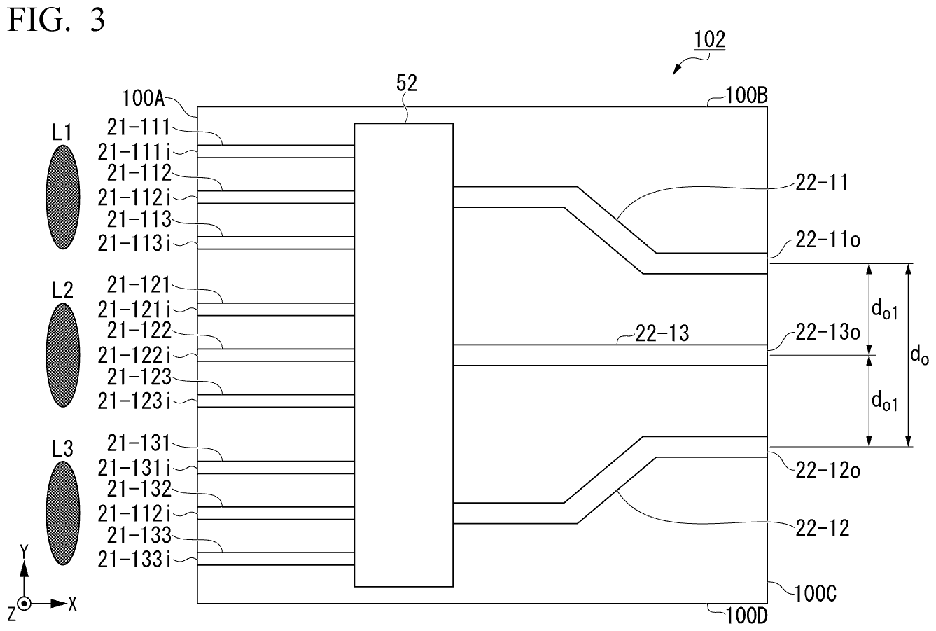

All the three light input side optical waveguides (21-1, 21-2, and 21-3) and the two light output side optical waveguides (22-1 and 22-2) shown in FIG. 1 are constituted to linearly extend in the x direction, but they are not limited to such a constitution. For example, as in the light output side optical waveguides (22-11, 22-12, and 22-13) shown in FIG. 3, they may have a curved part.

### Optical Coupler (Second Embodiment)

FIG. 2 is a schematic plan view showing an optical coupler according to a second embodiment. The reference signs L1, L2, and L3 in the diagrams conceptually indicate three laser light beams. Description of members similar to those in the first embodiment may be omitted.

An optical coupler 101 shown in FIG. 2 is an optical coupler for coupling three laser light beams having different wavelengths and includes six light input ports (21-11i, 21-12i, 21-21i, 21-22i, 21-31i, and 21-32i) in total having two light input ports for each of the three laser light beams (L1, L2, and L3). The optical coupler 101 includes the two light output ports (22-1o and 22-2o) allowing three laser light beams to be coupled and emitted therethrough, six light input side optical waveguides (21-11, 21-12, 21-21, 21-22, 21-31, and 21-32) respectively extending from the six light input ports (21-11i, 21-12i, 21-21i, 21-22i, 21-31i, and 21-32i), the two light output side optical waveguides (22-1 and 22-2) respectively extending from the two light output ports (22-1o and 22-2o), and an optical coupling part 51 having the six light input side optical waveguides (21-11, 21-12, 21-21, 21-22, 21-31, and 21-32) and the two light output side optical waveguides (22-1 and 22-2) connected thereto.

The optical coupler 101 includes two light input ports for inputting laser light for each light beam. By providing a plurality of light input ports for inputting laser light for each light beam, the power density of laser light guided through the light input side optical waveguides can be dispersed so that damage to the light input side optical waveguides can be curbed.

That is, since the optical coupler according to the second embodiment is constituted to include not only the light output side optical waveguides but also a plurality of light input side optical waveguides for each light beam, the power density of laser light guided through the light input side optical waveguides can be dispersed so that damage to the light input side optical waveguides can also be curbed.

It is preferable that an interval di between the light input ports 21-11i and 21-12i, the interval di between the light input ports 21-21i and 21-22i, and the interval di between the light input ports 21-31i and 21-32i be 0.5 μm or smaller.

Since laser light spreads out in a Gaussian shape, power becomes stronger toward the center. For this reason, power of the laser light L1 is input to the light input side optical waveguides as much as possible. In addition, if the interval between the light input ports is 0.5 μm or smaller, degradation in coupling efficiency between a laser and the light input side optical waveguides can be curbed.

Similar to the first embodiment, it is preferable that the interval dₒ between the two light output ports 22-1o and 22-2o be 25 μm or smaller. This is because laser light beams appear as one beam, resulting in a clear video image when the optical coupler 101 is applied to retinal projection XR glasses or the like. Here, as shown in FIG. 2, the interval dₒ is a distance between the center of the light output port 22-1o and the center of the light output port 22-2o.

The optical coupling part 51 is a six-input two-output type MMI optical coupler.

### Optical Coupler (Third Embodiment)

FIG. 3 is a schematic plan view showing an optical coupler according to a third embodiment. The reference signs L1, L2, and L3 in the diagrams conceptually indicate three laser light beams. Description of members similar to those in the foregoing embodiments may be omitted.

An optical coupler 102 shown in FIG. 3 is an optical coupler for coupling three laser light beams having different wavelengths and includes nine light input ports (21-111i, 21-112i, 21-113i, 21-121i, 21-122i, 21-123i, 21-131i, 21-132i, and 21-133i) in total having three light input ports for each of the three laser light beams (L1, L2, and L3). The optical coupler 102 includes three light output ports (22-11o, 22-12o, and 22-13o) allowing three laser light beams to be coupled and emitted therethrough, nine light input side optical waveguides (21-111, 21-112, 21-113, 21-121, 21-122, 21-123, 21-131, 21-132, and 21-133) respectively extending from the nine light input ports (21-111i, 21-112i, 21-113i, 21-121i, 21-122i, 21-123i, 21-131i, 21-132i, and 21-133i), the three light output side optical waveguides (22-11, 22-12, and 22-13) respectively extending from the three light output ports (22-11o, 22-12o, and 22-13o), and an optical coupling part 52 having the nine light input side optical waveguides (21-111, 21-112, 21-113, 21-121, 21-122, 21-123, 21-131, 21-132, and 21-133) and the three light output side optical waveguides (22-11, 22-12, and 22-13) connected thereto.

The optical coupler 102 is constituted to include three light output ports for outputting laser light and include three light output side optical waveguides respectively leading to the three light output ports. By providing a plurality of light output side optical waveguides, the power density of laser light guided through the optical waveguides can be dispersed so that damage to the optical waveguides can be curbed.

Similar to the optical coupler according to the second embodiment, since the optical coupler according to the third embodiment is constituted to include not only the light output side optical waveguides but also a plurality of light input side optical waveguides for each light beam, the power density of laser light guided through the light input side optical waveguides can be dispersed so that damage to the light input side optical waveguides can also be curbed.

Similar to the first embodiment, in the three light output ports 22-11o, 22-12o, and 22-13o, it is preferable that the interval dₒ between the two light output ports 22-11o and 22-12o at both ends be 25 μm or smaller. It is preferable that an interval dₒ₁ between the two adjacent light output ports 22-11o and 22-13o and the interval dₒ₁ between the two light output ports 22-12o and 22-13o be 10 μm or smaller.

This is because laser light beams appear as one beam, resulting in a clear video image when the optical coupler 102 is applied to retinal projection XR glasses or the like. Here, as shown in FIG. 2, the interval dₒ is a distance between the center of the light output port 22-1o and the center of the light output port 22-2o.

Similar to the optical coupler 101 shown in FIG. 2, in the light input ports for the respective rays L1, L2, and L3 of laser light, it is preferable that the interval between adjacent light input ports be 0.5 μm or smaller.

That is, it is preferable that the interval between the light input ports 21-111i and 21-112i, the interval between the light input ports 21-112i and 21-113i, the interval between the light input ports 21-121i and 21-122i, the interval between the light input ports 21-122i and 21-123i, the interval between the light input ports 21-131i and 21-132i, and the interval between the light input ports 21-132i and 21-133i be 0.5 μm or smaller. Since laser light spreads out in a Gaussian shape, power becomes stronger toward the center. For this reason, power of the laser light L1 is input to the light input side optical waveguides as much as possible. In addition, if the interval between the light input ports is 0.5 μm or smaller, degradation in coupling efficiency between a laser and the light input side optical waveguides can be curbed.

The optical coupling part 52 is a six-input three-output type MMI optical coupler.

### [Optical Coupling Member]

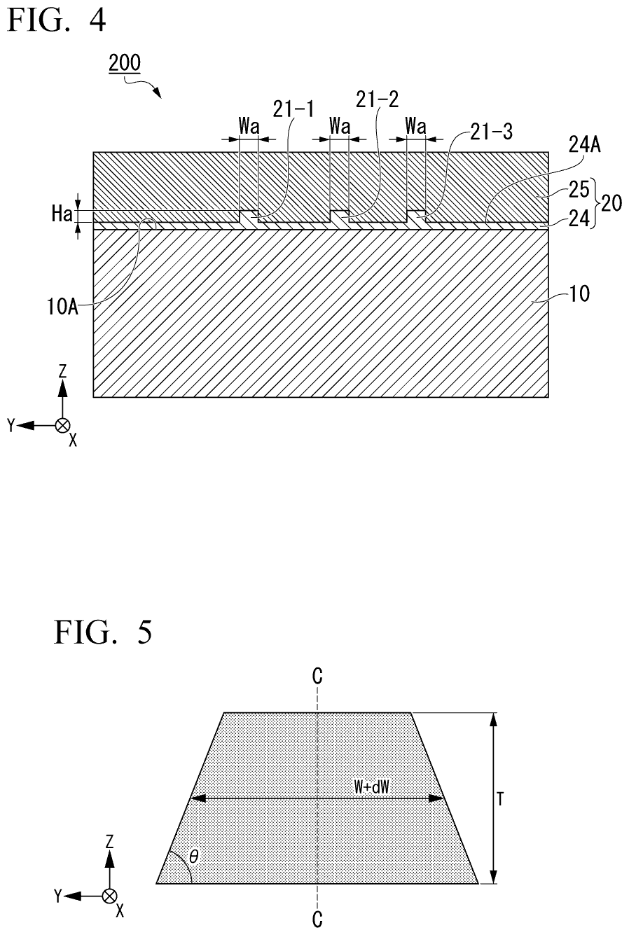

An optical coupling member according to the embodiment of the present disclosure includes a substrate that is made of a material different from lithium niobate, and an optical coupling function layer that is formed on a main surface of the substrate and is constituted of a lithium niobate film. The optical coupler according to the foregoing embodiments is formed in the optical coupling function layer. Regarding the constituent elements which will be described below, the same reference signs are applied to constituent elements having functions similar to those in the foregoing embodiments and description thereof may be omitted. An optical coupling member 200 shown in FIG. 4 will be described with an example in which the optical coupler 100 shown in FIG. 1 is formed in the optical coupling function layer.

FIG. 4 is a schematic cross-sectional view, which is cut along a YZ plane (X-X′ in FIG. 1), of the optical coupling member 200 in which the optical coupler 100 shown in FIG. 1 is formed in the optical coupling function layer made of lithium niobate.

The optical coupling member 200 shown in FIG. 4 includes a substrate 10 that is made of a material different from lithium niobate, and an optical coupling function layer 20 that is formed on a main surface of the substrate 10 and is made of lithium niobate. The light input ports, the light output ports, the optical coupling part, the input tapered portions, the output tapered portions, the light input side optical waveguides, and the light output side optical waveguides are formed in the optical coupling function layer 20.

In the optical coupling member 200, when a refractive index difference between a waveguide core film and a waveguide cladding film is Δn, if the waveguide core film is made of lithium niobate, it can be designed to have a larger Δn than in the case of using a material such as a glass, and curvature radii of the optical waveguides can be reduced. Moreover, increase in coupling length is prevented using a multimode-interference-type optical coupling part compared to the case of using a directional coupler, and therefore both improvement in degree of freedom in design and miniaturization can be achieved.

The optical coupling function layer 20 is constituted of a waveguide core film 24 which is constituted of a lithium niobate film having the light input ports, the light output ports, the optical coupling part, the light input side optical waveguides, and the light output side optical waveguides formed thereon; and a waveguide cladding (buffer) film 25 which is formed on the waveguide core film 24 such that these are covered. Hereinafter, the reference sign 24 may also be used for the lithium niobate film.

Examples of the substrate 10 can include a sapphire substrate, a Si substrate, and a thermal oxidation silicon substrate.

Since the optical coupling function layer 20 is constituted of a lithium niobate (LiNbO₃) film, it is not particularly limited as long as it has a lower refractive index than the lithium niobate film. However, a sapphire single crystal substrate or a silicon single crystal substrate is preferably used as a substrate on which a single crystal lithium niobate film can be formed as an epitaxial film. The crystal orientation of the single crystal substrate is not particularly limited. However, for example, since the lithium niobate film with a c-axis orientation has three-fold symmetry, it is desirable that the single crystal substrate (base) also have the same symmetry, and it is preferable to use a substrate having a c plane in the case of a sapphire single crystal substrate and use a substrate having a (111) plane in the case of a silicon single crystal substrate.

For example, the lithium niobate film is a c-axis oriented lithium niobate film. For example, the lithium niobate film is an epitaxial film which is epitaxially grown on the substrate 10. The epitaxial film denotes a single crystal film in which the crystal orientation is aligned by the base substrate. The epitaxial film is a film having a single crystal orientation in a z direction and an in-plane direction within an xy plane, in which crystals are oriented in a manner of being aligned in all of an x axis direction, a y axis direction, and a z axis direction. Whether or not a film formed on the substrate 10 is an epitaxial film can be verified by checking the peak intensity and the pole at the orientation position in 2θ-θ X-ray diffraction, for example.

Specifically, when measurement is performed with 2θ-θ X-ray diffraction, all peak intensities except for that in a target plane are equal to or lower than 10% and are preferably equal to or lower than 5% of the maximum peak intensity in the target plane. For example, when the lithium niobate film is a c-axis oriented epitaxial film, the peak intensities except for that in a (OOL) plane are equal to or lower than 10% and are preferably equal to or lower than 5% of the maximum peak intensity in the (00L) plane. Here, (00L) is a general term for equivalent planes such as (001) and (002).

In addition, conditions for confirming the peak intensity at the orientation position described above simply indicate the orientation in one direction. Thus, even if the conditions described above are met, when the crystal orientation is not aligned within a plane, the intensity of X-rays does not increase at a particular angular position, and no poles are observed. For example, in the case of the lithium niobate film, since LiNbO₃ has a trigonal crystal structure, there are three poles of LiNbO₃ (014) in a single crystal. In the case of lithium niobate, it is known that epitaxial growth occurs in a so-called twin crystal state in which crystals rotated by 180° about the c-axis are symmetrically coupled. In this case, since two poles are in a symmetrically coupled state in each of three poles, there are six poles. In addition, when a lithium niobate film is formed on a silicon single crystal substrate having a (100) plane, since the substrate has four-fold symmetry, twelve poles (4×3=12) are observed. In the present disclosure, a lithium niobate film which has been epitaxially grown in a twin crystal state is also included in an epitaxial film.

The composition of lithium niobate is LiₓNbA_{y}O_{z}. A is an element other than Li, Nb, and O. The subscript x is 0.5 to 1.2 and is preferably 0.9 to 1.05. The subscript y is 0 to 0.5. The subscript z is 1.5 to 4.0 and is preferably 2.5 to 3.5. For example, the element A is K, Na, Rb, Cs, Be, Mg, Ca, Sr, Ba, Ti, Zr, Hf, V, Cr, Mo, W, Fe, Co, Ni, Zn, Sc, or Ce, and two or more kinds of these elements may be combined.

Moreover, a lithium niobate single crystal thin film pasted on a substrate may be adopted as the lithium niobate film.

The film thickness of the lithium niobate film is 2 μm or smaller, for example. The film thickness of the lithium niobate film indicates the film thickness of a part other than ridges. Optimal design of the film thickness of the lithium niobate film may be suitably performed in accordance with the wavelength, the ridge shape, and the like used.

A waveguide is a ridge protruding from a first surface 24A of the lithium niobate film 24. The first surface 24A is an upper surface of the lithium niobate film 24 in a part (slab layer) except for the ridges.

As shown in FIG. 4, cross-sectional shape forming portions of the light input side optical waveguides 21-1, 21-2, and 21-3 each have a rectangular cross-sectional shape. However, they need only have a shape capable of guiding light. For example, they may have a trapezoidal shape, a triangular shape, a semicircular shape, or the like. Widths Wa of three ridges in a y direction are preferably 0.2 μm to 5.0 μm, and heights of the three ridges (protrusion heights Ha from the first surface 24A) are preferably 0.1 μm to 1.0 μm, for example. The same applies to other optical waveguides.

Propagation in a single mode can be achieved by setting the sizes of the light input side optical waveguides 21-1, 21-2, and 21-3, and other optical waveguides shown in FIG. 1 to approximately the wavelength of laser light.

### <MMI Optical Coupling Part>

### (1) MMI Optical Coupling Part Having Trapezoidal Cross Section

The optical coupling part described above is an MMI optical coupler (which may hereinafter be referred to as “an MMI optical coupling part”).

As shown in FIG. 5, it may be preferable that a cross section of the MMI optical coupling part cut in a vertical direction with respect to a traveling direction of light has a trapezoidal shape. In addition, it may be preferable that an angle of inclination θ of this trapezoidal shape be 40° to 85°.

This is because a dimensional margin of a width W of the MMI optical coupling part is improved, an optimal width of the MMI optical coupling part increases, and processing is facilitated.

This result was obtained by comparing propagation losses of three-color (RGB) light through a simulation between when a cross section of the MMI optical coupling part cut in the vertical direction with respect to the traveling direction of light had a trapezoidal shape and when it had a rectangular shape.

Regarding a model used in this simulation, the simulation was performed for propagation losses during RGB coupling by setting a height T of the MMI optical coupling part (ridge) to 0.7 μm, having the width W at ½ of the height T of the MMI optical coupling part, and increasing or decreasing the fixed angle of inclination θ between a lower surface and inclined portions with respect to both sides by dW/2 (therefore, dW in total) with a fixed center C-C of the ridge.

In the 2×1 MMI optical coupler coupling two color laser light beams, when 0 was 85°, 70°, and 40°, the margin was 0.3 μm in all cases, and the optimal width W was 6.6 μm, 6.6 μm, and 6.9 μm, respectively.

### (2) MMI Optical Coupling Part Having Slab Portion

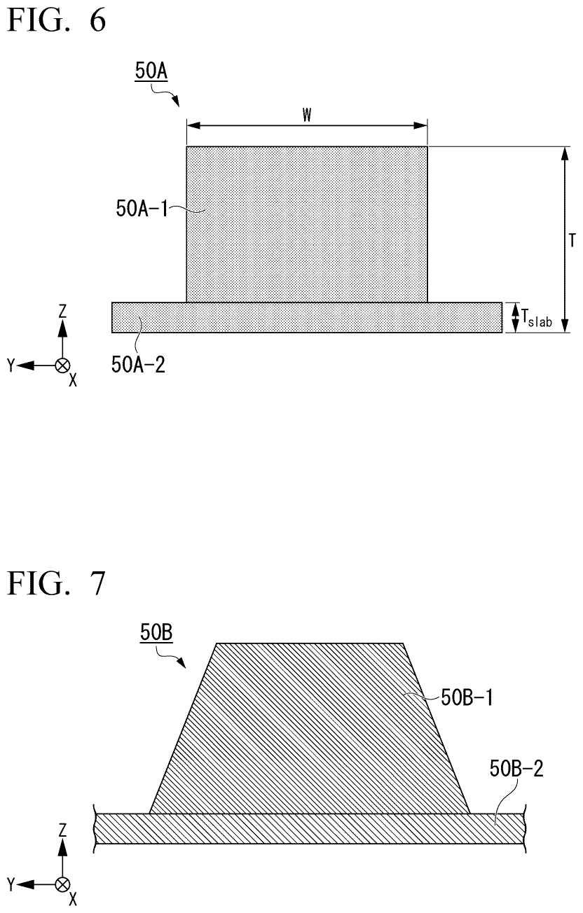

As shown in FIG. 6, the MMI optical coupling part may be provided with a slab portion on the substrate side.

An MMI optical coupling part 50A shown in FIG. 6 has a ridge 50A-1 and further has a slab portion 50A-2 on the substrate side.

By having a slab portion, the width dimensional margin may further expand and processing may be further facilitated. In addition, the optimal width W may further expand and processing may be further facilitated. When the MMI optical coupling part had the constitution of the model shown in FIG. 6, a simulation was performed for propagation losses (dB) in a basic mode (TM0) and higher-order modes (TM1 and TM2) during RGB coupling of each of three RGB colors. It was assumed that a height Tslab of the slab portion was set to 0.2 μm and the height T of the MMI optical coupling part was the sum of the height of the ridge 50A-1 and the height of the slab portion 50A-2. The width W of the MMI optical coupling part was set to 6.5 μm.

For comparison, when the propagation losses of light in the case of having no slab portion and the case of having a slab portion were compared to each other, the difference among the propagation loss of RGB was smaller in the case of having a slab portion than in the case of having no slab portion. In addition, from the difference in propagation loss between the case of having a slab portion and the case of having no slab portion, it was possible to obtain a result showing that the propagation loss increased in the higher-order modes and propagation was curbed. Therefore, it was ascertained that providing a slab portion is effective for realizing single-mode laser light.

In addition, as shown in FIG. 7, an MMI optical coupling part 50B having a trapezoidal cross section may have a ridge 50B-1 and may further have a slab portion 50B-2 on the substrate side. By having a slab portion, the width dimensional margin may further expand, the optimal width W may further expand, and processing may be further facilitated.

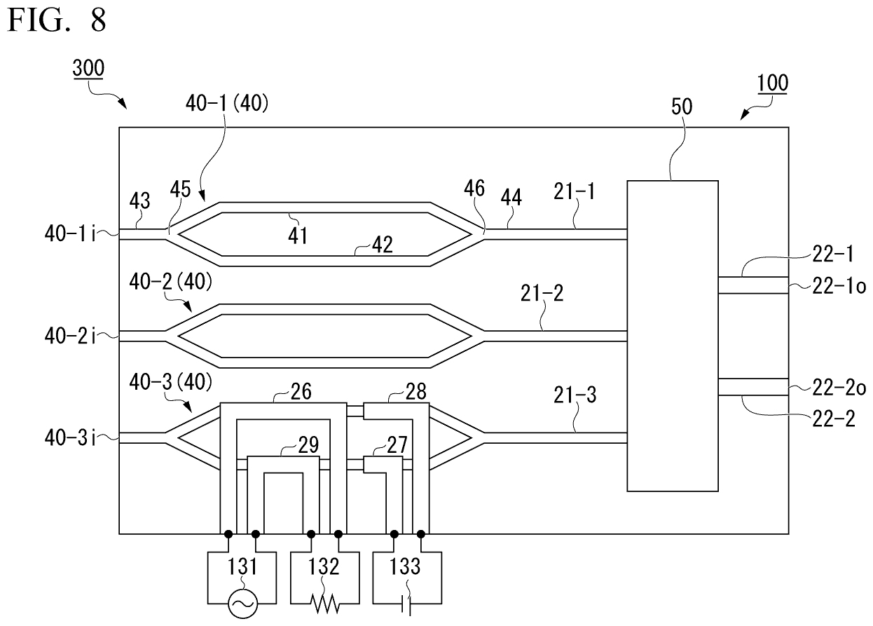

FIG. 8 is a schematic plan view of a modification example of an optical coupling member according to the embodiment of the present disclosure.

An optical coupling member 300 shown in FIG. 8 is an optical coupling member with an optical modulation function including the substrate 10 that is made of a material different from lithium niobate (refer to FIG. 4), and the optical coupling function layer 20 that is formed on the main surface of the substrate 10 and is constituted of a lithium niobate film, and it has an optical modulation function inside the optical coupling function layer 20.

The optical coupling member 300 with an optical modulation function has the optical coupling part 50 according to the foregoing embodiment (refer to FIG. 1), and a Mach-Zehnder optical modulator 40.

The Mach-Zehnder optical modulator 40 includes three Mach-Zehnder optical waveguides 40-1, 40-2, and 40-3.

A known Mach-Zehnder optical modulator or known optical waveguides can be used as the Mach-Zehnder optical modulator 40, and laser light beams having the same wavelengths and the same phases are each divided (caused to branch) into two beams forming a pair and are joined (coupled) together after different phases are respectively applied thereto. The intensity of the coupled light beam varies depending on the phase difference.

Each of the Mach-Zehnder optical waveguides 40 (40-1, 40-2, and 40-3) shown in FIG. 8 has a first optical waveguide 41, a second optical waveguide 42, an input path 43, an output path 44, a branching portion 45, and a coupling portion 46.

The output path 44 of the Mach-Zehnder optical waveguide 40-1 leads to the light input side optical waveguide 21-1 of the optical coupling part 50. In addition, the output path 44 of the Mach-Zehnder optical waveguide 40-2 leads to the light input side optical waveguide 21-2 of the optical coupling part 50. In addition, the output path 44 of the Mach-Zehnder optical waveguide 40-3 leads to the light input side optical waveguide 21-3 of the optical coupling part 50.

The first optical waveguide 41 and the second optical waveguide 42 shown in FIG. 8 are constituted to linearly extend in the x direction except for a part in the vicinity of the branching portion 45 and a part in the vicinity of the coupling portion 46, but they are not limited to such a constitution. The lengths of the first optical waveguide 41 and the second optical waveguide 42 shown in FIG. 8 are substantially the same. The branching portion 45 is provided between the input path 43, and the first optical waveguide 41 and the second optical waveguide 42. The input path 43 leads to the first optical waveguide 41 and the second optical waveguide 42 via the branching portion 45. The coupling portion 46 is provided between the first optical waveguide 41 and the second optical waveguide 42, and the output path 44. The first optical waveguide 41 and the second optical waveguide 42 lead to the output path 44 via the coupling portion 46.

Electrodes 29 and 26 are electrodes for applying a modulation voltage to each of the Mach-Zehnder optical waveguides 40-1, 40-2, and 40-3 (which may hereinafter be simply referred to as “each of the Mach-Zehnder optical waveguides 40”). The electrode 29 is an example of a first electrode, and the electrode 26 is an example of a second electrode. One end of the electrode 29 is connected to a power source 131, and the other end is connected to a terminating resistor 132. One end of the electrode 26 is connected to the power source 131, and the other end is connected to the terminating resistor 132. The power source 131 is a part of a drive circuit for applying a modulation voltage to each of the Mach-Zehnder optical waveguides 40. For the sake of simplification of the drawings, the electrodes 29 and 26 are depicted only in the part of the Mach-Zehnder optical waveguide 40-3.

Electrodes 27 and 28 are electrodes for applying a DC bias voltage to each of the Mach-Zehnder optical waveguides 40. One end of the electrode 27 and one end of the electrode 28 are connected to a power source 133. The power source 133 is a part of a DC bias applying circuit for applying a DC bias voltage to each of the Mach-Zehnder optical waveguides 40.

When a DC bias voltage is superimposed on the electrodes 29 and 26, the electrodes 27 and 28 may not be provided. In addition, a ground electrode may be provided around the electrodes 29, 26, 27, and 28.

The optical coupling member 300 is constituted to have light input ports 40-1i, 40-2i, and 40-3i respectively for three laser light beams and have the light input side optical waveguides respectively for the light input ports. However, as shown in FIGS. 2 and 3, it may also be constituted to have a plurality of light input ports, such as two light input ports or three light input ports for each of three laser light beams and have the light input side optical waveguides respectively for the light input ports.

In this case, each of the light input side optical waveguides can serve as a Mach-Zehnder optical waveguide. In addition, some of the light input side optical waveguides can also serve as Mach-Zehnder optical waveguides.

In addition, regarding the light output ports as well, the optical coupling member 300 may also be constituted to have three or more light output ports and have the light output side optical waveguides respectively for the light output ports.

### Visible Light Source Module (First Embodiment)

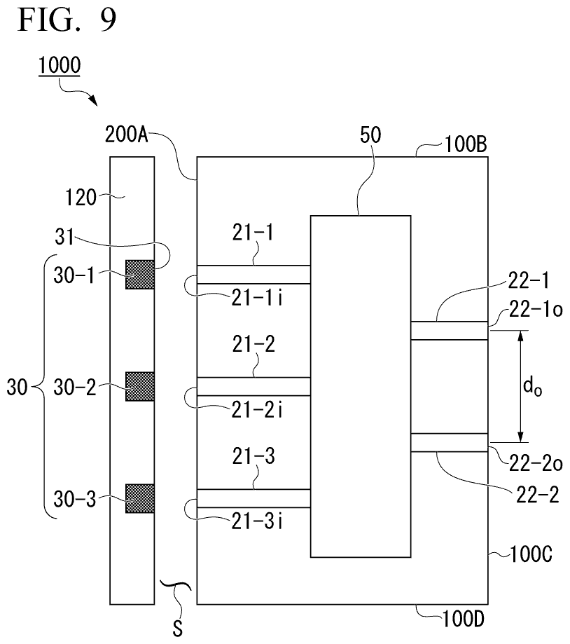

A visible light source module according to the first embodiment includes the optical coupling member according to the foregoing embodiments, and a plurality of visible laser light sources that emit visible light coupled by the optical coupling member. FIG. 9 is a schematic plan view of a visible light source module according to the present embodiment. FIG. 9 shows an example of a visible light source module including the optical coupling member 200 shown in FIG. 4.

A visible light source module 1000 shown in FIG. 9 includes the optical coupling member 200 that includes the optical coupling part 50, and three visible laser light sources 30 (30-1, 30-2, and 30-3) that emit visible light coupled by the optical coupling member 200. The optical coupling member 200 includes the substrate 10 that is made of a material different from lithium niobate (refer to FIG. 4), and the optical coupling function layer 20 (refer to FIG. 4) that is formed on the main surface of the substrate 10 and is made of lithium niobate, and it has a side surface 200A serving as a light incidence surface.

Regarding the constituent elements shown in FIG. 9, the same reference signs are applied to constituent elements having functions similar to those above and description thereof may be omitted.

Various kinds of laser elements can be used as the visible laser light sources 30. For example, commercially available laser diodes (LDs) of red light, green light, blue light, and the like can be used. Light having a peak wavelength of 600 nm to 750 nm can be used as red light, light having a peak wavelength of 500 nm to 600 nm can be used as green light, and light having a peak wavelength of 380 nm to 500 nm can be used as blue light.

In the visible light source module 1000, for example, the visible laser light sources 30-1, 30-2, and 30-3 respectively serve as an LD emitting red light, an LD emitting green light, and an LD emitting blue light. The LDs 30-1, 30-2, and 30-3 are disposed with an interval therebetween in a direction substantially orthogonal to an emission direction of light emitted from each of the LDs and are provided on an upper surface of a subcarrier 120.

In the visible light source module 1000, a case in which the number of visible laser light sources is three has been described as an example. However, as long as there are a plurality of visible laser light sources, the number thereof is not limited to three and may be two or four or more. The plurality of visible laser light sources may all have different wavelengths of emitted light, and there may be visible laser light sources having the same wavelengths of emitted light. In addition, light other than red (R), green (G), and blue (B) can also be used as emitted light. A mounting order of red (R), green (G), and blue (B) described using the drawings does not need to be in this order and can be suitably changed.

The LDs 30 can be mounted on the subcarrier 120 as bare chips. For example, the subcarrier 120 is constituted using aluminum nitride (AlN), aluminum oxide (Al₂O₃), silicon (Si), or the like.

The subcarrier 120 can be constituted to be directly bonded to the substrate 10 with a metal bonding layer therebetween. Due to this constitution, spatial coupling or fiber coupling is not performed, and therefore further miniaturization can be achieved.

Due to the constitution in which the subcarrier 120 and the substrate 10 are bonded with a metal bonding layer therebetween, the optical axes of laser light beams can be positionally aligned (active alignment) by adjusting relative positions of the subcarrier 120 and the substrate 10 at the time of manufacturing such that the optical axis of each visible light laser matches the axis of each of the first light input side optical waveguide 21-1, the second light input side optical waveguide 21-2, and the third light input side optical waveguide 21-3.

In the visible light source module 1000, the three light input ports 21-1i, 21-2i, and 21-3i of the optical coupling part 50 respectively face emission ports of the LDs 30 (30-1, 30-2, and 30-3) and are positionally set such that laser light beams emitted from emission surfaces of the LDs 30 can be respectively incident on the light input ports 21-1i, 21-2i, and 21-3i. In addition, the axis of each of the light input side optical waveguides 21-1, 21-2, and 21-3 is substantially superimposed on the optical axis of laser light emitted from the emission port of each of the LDs 30. Due to such a constitution and disposition, red light, green light, and blue light emitted from the LDs 30-1, 30-2, and 30-3 can be incident on the three light input side optical waveguides 21-1, 21-2, and 21-3 of the optical coupling part 50.

In the visible light source module 1000, light emission surfaces 31 of the LDs 30 and a light incidence surface 200A of the optical coupling member 200 are disposed with a predetermined interval therebetween. The light incidence surface 200A faces the light emission surfaces 31, and there is a gap S between the light emission surfaces 31 and the light incidence surface 200A in the x direction. Since the visible light source module 1000 is exposed in the air, the gap S is filled with air. Since the gap S is in a state of being filled with the same gas (air), it is easy to cause laser light beams of colors respectively emitted from the LDs 30 to be incident on incidence paths in a state of satisfying predetermined coupling efficiency. When the visible light source module 1000 is used in AR glasses and VR glasses, in consideration of the amount of light and the like required for AR glasses and VR glasses, the size of the gap (interval) S in the x direction is larger than 0 μm and is equal to or smaller than 5 μm, for example.

### Visible Light Source Module (Second Embodiment)

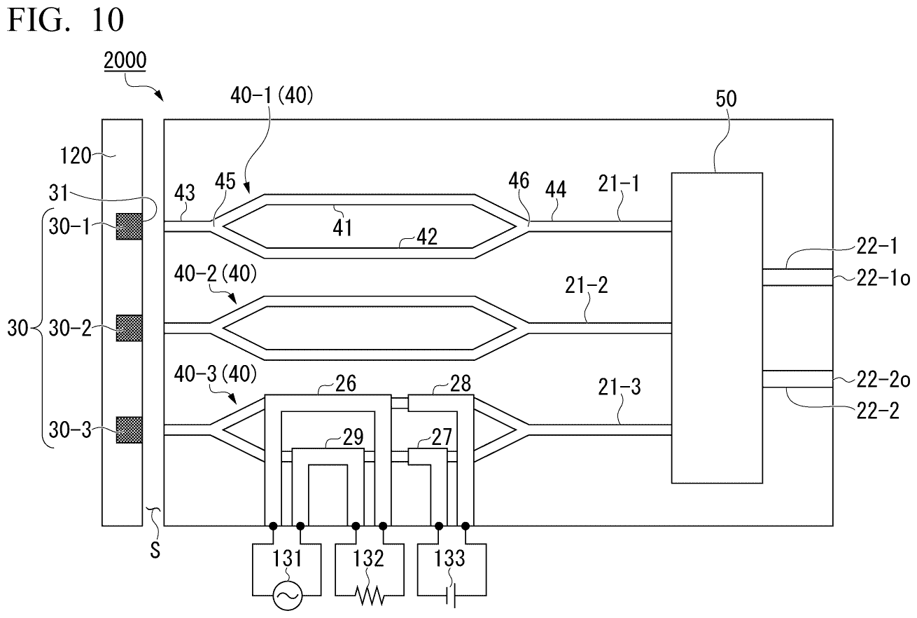

FIG. 10 is a schematic plan view of a visible light source module according to the second embodiment.

A visible light source module 2000 shown in FIG. 10 includes the optical coupling member 300 with an optical modulation function shown in FIG. 8, and the plurality of visible laser light sources 30 (30-1, 30-2, and 30-3) that emit visible light coupled by the optical coupling member 300 with an optical modulation function. The optical coupling member 300 includes the substrate 10 that is made of a material different from lithium niobate (refer to FIG. 4), and the optical coupling function layer 20 (refer to FIG. 4) that is formed on the main surface of the substrate 10 and is made of lithium niobate, and it has a side surface 300A.

Regarding the constituent elements shown in FIG. 10, the same reference signs are applied to constituent elements exhibiting functions similar to those above and description thereof may be omitted.

The visible light source module 2000 has the three Mach-Zehnder optical waveguides 40-1, 40-2, and 40-3, corresponding to the number of visible laser light sources 30-1, 30-2, and 30-3. The visible laser light sources 30-1, 30-2, and 30-3 and the light input ports 40-1i, 40-2i, and 40-3i (refer to FIG. 8) of the Mach-Zehnder optical waveguides 40-1, 40-2, and 40-3 are positionally set such that laser light beams emitted from the visible laser light sources are incident on the corresponding Mach-Zehnder optical waveguides.

The subcarrier 120 in which the visible laser light sources 30-1, 30-2, and 30-3 are mounted and the substrate 10 on which the optical coupling function layer 20 having the optical coupling member 300 with an optical modulation function is formed can be constituted to be directly bonded with a metal bonding layer therebetween. Due to this constitution, spatial coupling or fiber coupling is not performed, and therefore further miniaturization can be achieved.

In addition, the optical axes of laser light beams can be positionally aligned (active alignment) by adjusting the relative positions of the subcarrier 120 and the substrate 10 at the time of manufacturing such that the optical axis of each visible light laser matches the axis of the input path 43 of each of the Mach-Zehnder optical waveguides 40-1, 40-2, and 40-3.

For example, the size of the optical coupling function layer 20 is 100 mm² or smaller. If the size of the optical coupling function layer 20 is 100 mm² or smaller, it is suitable for xR glasses such as AR glasses and VR glasses.

The optical coupling function layer 20 can be produced by a known method. For example, the optical coupling function layer 20 is manufactured using a semiconductor process such as epitaxial growth, photolithography, etching, vapor-phase growth, or metallization.

When the visible light source module according to the present disclosure is applied for xR glasses such as AR glasses and VR glasses, it is preferable that the widths of a first multimode-interference-type optical coupling part and a second multimode-interference-type optical coupling part constituting the optical coupler be approximately 1 to 1,000 μm, for example, and it is preferable that the lengths thereof be approximately 10 to 10,000 μm, for example.

For example, in a retinal projection display, in order to display an image with desired colors, there is a need for the respective intensities of three RGB colors expressing visible light to be independently modulated at a high speed. If such modulation is performed with respect to only the visible laser light sources (current modulation), the load on an IC controlling the modulation thereof will increase. However, modulation (voltage modulation) by the Mach-Zehnder optical modulator 40 (the optical coupling member 300 with an optical modulation function) can also be used together. In this case, coarse adjustment may be performed using a current (visible light laser light source) and fine adjustment may be performed using a voltage (the Mach-Zehnder optical modulator 40). Alternatively, coarse adjustment may be performed using a voltage (the Mach-Zehnder optical modulator 40) and fine adjustment may be performed using a current (visible light laser light source). Since fine adjustment performed using a voltage has better responsiveness, when responsiveness is regarded as important, it is preferable to employ the former method. Since fine adjustment performed using a current requires a lower current which restrains power consumption, when restraint of power consumption is regarded as important, it is preferable to employ the latter method.

### [Optical Engine]

In this specification, an optical engine is a device including a plurality of light sources, an optical system which includes a coupling part causing a plurality of laser light beams emitted from the plurality of light sources to become one ray of light, an optical scanning mirror which reflects light emitted from the optical system by changing an angle such that an image is displayed, and a control element which controls the optical scanning mirror.

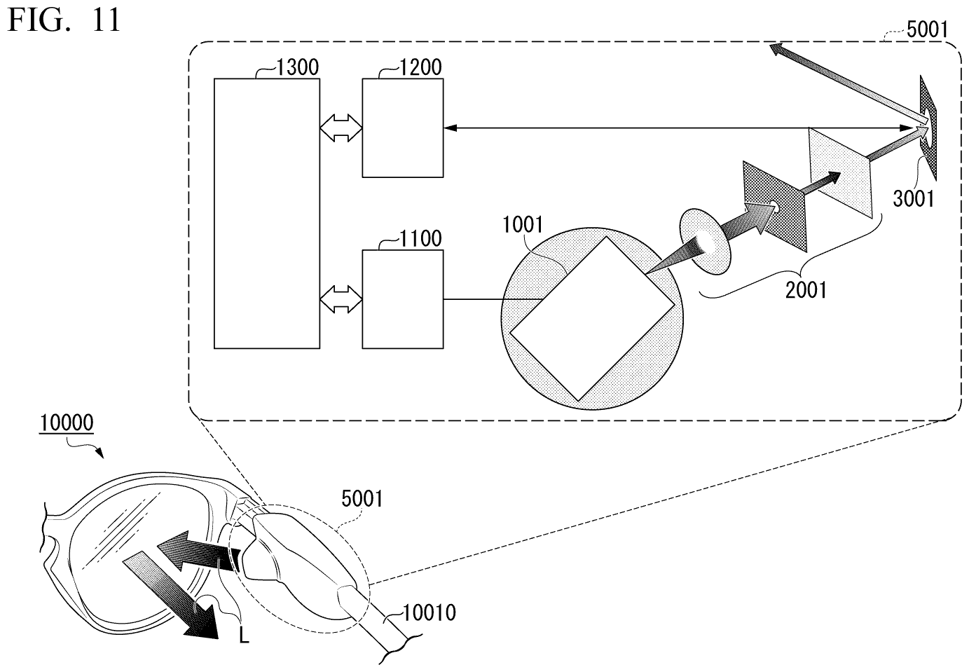

FIG. 11 shows an explanatory conceptual diagram of an optical engine 5001 according to the present embodiment. The diagram shows a state in which a frame 10010 of glasses 10000 is equipped with the optical engine 5001. The reference sign L indicates image display light.

The optical engine 5001 has a visible light source module 1001 and an optical scanning mirror 3001. The visible light source module according to the embodiments described above is used as the visible light source module 1001 to be provided in the optical engine 5001.

Irradiation laser light from the visible light source module 1001 attached to the glasses frame is reflected and scanned by the optical scanning mirror and enters the human eye so that an image (video image) is directly projected onto the retina.

For example, the optical scanning mirror 3001 is an MEMS mirror. In order to project a 2D image, it is preferable to adopt a two-axis MEMS mirror which vibrates so as to reflect laser light by changing the angle in the horizontal direction (X direction) and the vertical direction (Y direction).

The optical engine 5001 has a collimator lens 2001a, a slit 2001b, and an ND filter 2001c as an optical system for optically processing laser light emitted from the visible light source module 1001. This optical system is an example, and it may have a different constitution.

The optical engine 5001 has a laser driver 1100, an optical scanning mirror driver 1200, and a video controller 1300 which controls these drivers.

### Examples

Hereinafter, the present disclosure will be described in more detail using Examples. However, the present disclosure is not limited to the following Examples in any way.

In Example 1, an optical coupling member including an MMI optical coupler (three-input two-output type) having the constitution shown in FIG. 1 was used.

In Examples 2 and 4 to 8, optical coupling members including an MMI optical coupler (six-input two-output type) having the constitution shown in FIG. 2 was used.

Example 3 was an optical coupling member including an MMI optical coupler (nine-input three-output type) having the constitution shown in FIG. 3.

In Comparative Example 1, an optical coupling member including a three-input one-output type MMI optical coupler was used.

Examples 1 to 8 and Comparative Example employed constitutions in which the laser light sources of the lights L1, L2, and L3 of laser light (refer to FIGS. 2 and 3) were disposed in the order of RGB. The coupling efficiency with respect to a laser in Table 1 indicates the results investigated through simulations. Fimmwave (PHOTON Design Corporation) was used as simulation software. The coupling efficiency with respect to a laser indicates the proportion of the power of laser light which has been propagated to the light input side optical waveguides.

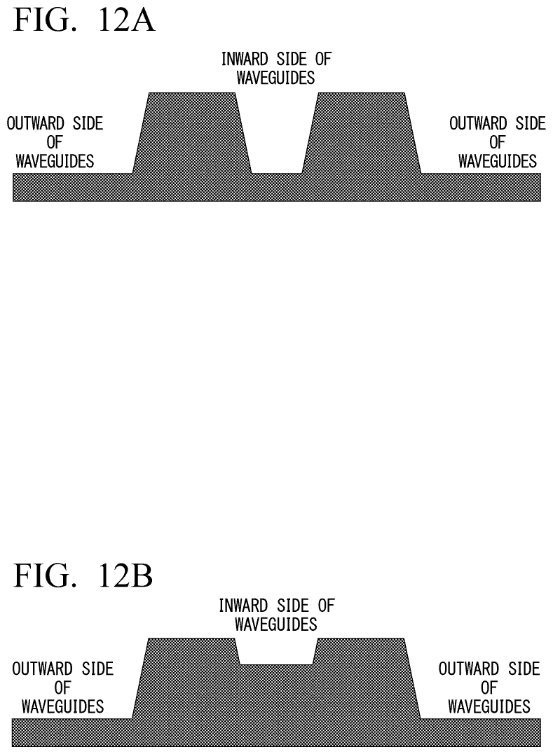

Each of the parameters in Table 1 will be described using Example 2 with reference to FIG. 2 and the like. The number of light output ports corresponds the numbers of light output ports 22-10 and 22-20. The interval between the light output ports at both ends corresponds to the distance indicated by the reference sign d₀ in the diagrams. The number of light input ports with respect to one light source corresponds to the number of light input ports for each of the lights L1, L2, and L3 of laser light. The distance from the laser emission surfaces to the light input ports corresponds to the gap S shown in FIGS. 9 and 10. The interval between adjacent light input ports corresponds to the distance indicated by the reference sign dᵢ in the diagrams. The thickness of the slab on the inward side of the waveguides in Examples 1 to 7 and Comparative Example 1 was set to be the same as the thickness of the slab on the outward side of the waveguides as shown in FIG. 12A, and the thickness thereof in Example 8 was set to be larger than the thickness of the slab on the outward side of the waveguides as shown in FIG. 12B.

TABLE 1

| | | Interval between | | Distance from laser | | Coupling | | |
|---|---|---|---|---|---|---|---|---|
| | | light output ports | Number of light | emission surfaces | Interval between | efficiency | Thickness of | |
| | Number of | farthest away | input ports with | to light input | adjacent light | with respect | slab on inward | |
| | light output | from each other | respect to one | ports | input ports | to laser | side of | Optical |
| | ports | [μm] | light source | [μm] | [μm] | [%] | waveguides | coupler |
| Example 1 | 2 | 25 | 1 | 1 | — | 60 | Same as that on | MMI |
| | | | | | | | outward side | |
| Example 2 | 2 | 25 | 2 | 2.5 | 0.5 | 40 | Same as that on | MMI |
| | | | | | | | outward side | |
| Example 3 | 3 | 10 | 3 | 4 | 0.5 | 40 | Same as that on | MMI |
| | | | | | | | outward side | |
| Example 4 | | 10 | 2 | 2.5 | 0.5 | 40 | Same as that on | MMI |
| | | | | | | | outward side | |
| Example 5 | 2 | 5 | 2 | 2.5 | 0.5 | 40 | Same as that on | MMI |
| | | | | | | | outward side | |
| Example 6 | 2 | 25 | 2 | 2.5 | 0.2 | 40 | Same as that on | MMI |
| | | | | | | | outward side | |
| Example 7 | 2 | 25 | 2 | 2.5 | 1 | 30 | Same as that on | MMI |
| | | | | | | | outward side | |
| Example 8 | 2 | 25 | 2 | 2.5 | 0.5 | 50 | Same as that on | MMI |
| | | | | | | | outward side | |
| Comparative | 1 | — | 1 | 1 | — | 60 | Larger than that | MMI |
| Example 1 | | | | | | | on outward side | |

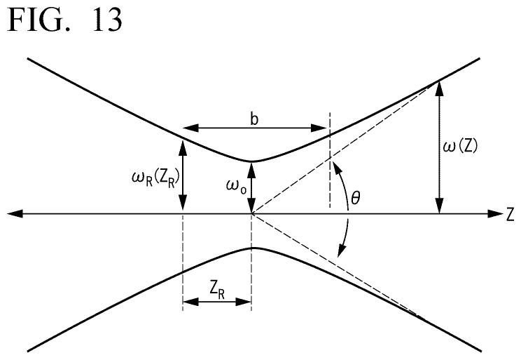

FIG. 13 is an explanatory view of a relationship between a laser beam diameter corresponding to each of Examples and a distance Z from a laser emission surface (corresponding to the gap S in FIGS. 9 and 10) in the case of a Gaussian beam.

The laser beam diameter is defined by the following Expression (2).

$$\begin{matrix}[ Math . 1 ] & \\ {w ( z )}^{2} = {w}_{0}^{2} + {θ}^{2} {z}^{2} = {w}_{0}^{2} + {( \frac{λ}{π {w}_{0}^{2}} )}^{2} {z}^{2} & ( 1 )\end{matrix}$$

$$w ( z ) = {w}_{0} \sqrt{1 + {( \frac{λ z}{π {w}_{0}^{2}} )}^{2}} \qquad ( 2 )$$

In Expressions (1) and (2), ω₀ indicates the beam waist (a value at which the beam diameter is minimized by diffraction), and Z indicates the distance from the laser light sources (corresponding to the gap S in FIGS. 9 and 10) (refer to FIG. 13). λ indicates the wavelength of laser light.

Table 2 shows the laser beam diameters [μm] of respective rays of RGB laser light when the distance Z from the laser emission surface was 1 μm, 2.5 μm, and 4 μm, respectively when the beam waist ω₀ was 0.2 μm. The distance Z=1 μm corresponds to Comparative Example 1 and Example 1, the distance Z=2.5 μm corresponds to Examples 2 and 4 to 8, and the distance Z=4 μm corresponds to Example 3.

TABLE 2

| Distance Z from | R | G | B |
|---|---|---|---|
| laser emission surface | (637 nm) | (520 nm) | (455 nm) |
| 1 μm | 2 μm | 1.7 μm | 1.4 μm |
| 2.5 μm | 5.1 μm | 4.1 μm | 3.6 μm |
| 4 μm | 8.1 μm | 6.6 μm | 5.8 μm |

From the results shown in Table 1, in the case of two or more light input ports for each light beam as well, when the interval between adjacent light input ports was 0.5 μm or smaller (Examples 2 to 6 and 8), the coupling efficiency with respect to a laser was 40%, and this indicated that a sufficient size could be obtained compared to 60% in the case of one light input port for each light beam (Example 1, Comparative Example 1).

In addition, Example 8 differed from Example 2 in that the thickness of the slab portion provided on the inward side of the light input side optical waveguides was larger than the thickness of the slab portion provided on the outward side of the light input side optical waveguides. Example 8 had higher coupling efficiency with respect to a laser than Example 2. It was ascertained that a constitution having such a thickness of the slab portion improved the coupling efficiency with respect to a laser.

Example 1 had a constitution in which two light output ports were provided and light was guided from the optical coupling part to the light output ports through two light output side optical waveguides in accordance with the number of light output ports. For this reason, compared to Comparative Example having a constitution in which one light output port was provided and light was guided from the optical coupling part to the light output port through one light output side optical waveguide, since the power density of laser light was dispersed into the two light output side optical waveguides while the coupling efficiency with respect to a laser remained the same (60%), deterioration in light output side optical waveguides could be curbed compared to Comparative Example. For this reason, Example 1 was also suitable for optical couplers for high-output lasers.

Examples 2 and 4 to 8 had a constitution in which two light output ports were provided and light was guided from the optical coupling part to the light output ports through two light output side optical waveguides in accordance with the number of light output ports. For this reason, compared to Comparative Example having a constitution in which one light output port was provided and light was guided from the optical coupling part to the light output port through one light output side optical waveguide, since the power density of laser light was dispersed into the two light output side optical waveguides without significantly degrading the coupling efficiency with respect to a laser (30% to 50% in Examples 2 and 4 to 8 compared to 60% in Comparative Example), deterioration in light output side optical waveguides could be curbed compared to Comparative Example. Moreover, Examples 2 and 4 to 8 had a constitution in which two light input ports were provided for each of the laser light sources and laser light beams incident on two light input ports were respectively guided to the optical coupling part through two light input side optical waveguides for each of the laser light sources. Since the power density of each light beam was dispersed into the two light input side optical waveguides, deterioration in light input side optical waveguides could be curbed compared to Comparative Example. For this reason, Examples 2 and 4 to 8 were also suitable for optical couplers for high-output lasers.

Example 3 had a constitution in which three light output ports were provided and light was guided from the optical coupling part to the light output ports through three light output side optical waveguides in accordance with the number of light output ports. For this reason, compared to Comparative Example having a constitution in which one light output port was provided and light was guided from the optical coupling part to the light output ports through one light output side optical waveguide, since the power density of laser light was dispersed into the three light output side optical waveguides without significantly degrading the coupling efficiency with respect to a laser (40% in Example 3 compared to 60% in Comparative Example), deterioration in light output side optical waveguides could be curbed compared to Comparative Example. Moreover, Example 3 had a constitution in which three light input ports were provided for each of the laser light sources and laser light beams incident on three light input ports were respectively guided to the optical coupling part through three light input side optical waveguides for each of the laser light sources. Since the power density of each light beam was dispersed into the three light input side optical waveguides, deterioration in light input side optical waveguides could be curbed compared to Comparative Example. For this reason, Example 3 was also suitable for optical couplers for high-output lasers.

### EXPLANATION OF REFERENCES

10 Substrate
20 Optical coupling function layer
30 Visible light laser light source
40 Mach-Zehnder optical modulator
50, 51, 52 Optical coupling part
100, 101, 102 Optical coupler
200, 300 Optical coupling member
1000 2000 Visible light source module

1. An optical coupler for coupling a plurality of laser light beams having different wavelengths, the optical coupler comprising:
a plurality of light input ports configured to allow the plurality of laser light beams to be respectively incident therethrough;
two or more light output ports configured to allow the plurality of laser light beams to be coupled and emitted therethrough;
a plurality of light input side optical waveguides configured to respectively extend from the plurality of light input ports;
two or more light output side optical waveguides configured to respectively extend from the two or more light output ports; and
an optical coupling part configured to have the plurality of light input side optical waveguides and the two or more light output side optical waveguides connected thereto.

2. The optical coupler according to claim 1,
wherein the plurality of light input ports include two or more light input ports for at least one light beam.

3. The optical coupler according to claim 2,
wherein the plurality of light input ports are constituted of two or more light input ports for each of all laser light beams.

4. The optical coupler according to claim 1,
wherein in the two or more light output ports, an interval between light output ports farthest away from each other is 25 μm or smaller.

5. The optical coupler according to claim 2,
wherein in two or more light input ports provided for one light beam, an interval between adjacent light input ports is 0.5 μm or smaller.

6. The optical coupler according to claim 1,
wherein a thickness of a slab portion provided on an inward side of the light input side optical waveguides is larger than a thickness of a slab portion provided on an outward side of the light input side optical waveguides.

7. The optical coupler according to claim 1,
wherein the optical coupling part is a multimode-interference-type coupling part.

8-13. (canceled)

14. An optical coupling member comprising:
a substrate configured to be made of a material different from lithium niobate; and
an optical coupling function layer configured to be formed on a main surface of the substrate and be constituted of a lithium niobate film,
wherein the optical coupler according to claim 1 is formed in the optical coupling function layer.

15. A visible light source module comprising:
the optical coupling member according to claim 14; and
a plurality of visible laser light sources configured to emit visible light lasers coupled by the optical coupling member.

16. An optical coupling member with an optical modulation function comprising:
a Mach-Zehnder optical modulator configured to be provided inside the optical coupling function layer of the optical coupling member according to claim 14.

17. A visible light source module comprising:
the optical coupling member with an optical modulation function according to claim 16; and
a plurality of visible laser light sources configured to emit visible light lasers coupled by the optical coupling member with an optical modulation function.

18. An optical engine comprising:
the visible light source module according to claim 15; and
a light scanning mirror configured to reflect light emitted from the visible light source module at various angles for image display.

19. An optical engine comprising:
the visible light source module according to claim 17; and
a light scanning mirror configured to reflect light emitted from the visible light source module at various angles for image display.
